(19) United States
(12) Patent Application Publication
(10) Pub. No.: US 2010/0050461 A1
(43) Pub. Date: Mar. 4, 2010

(54) PAPER MACHINE

(76) Inventors: Robert Attwenger, Wien (AT); Herbert Boden, St. Pölten (AT); Rainer Kloibhofer, Neumarkt (AT)

Correspondence Address: TAYLOR & AUST, P.C., P.O. Box 560, 142. S Main Street, Avilla, IN, 46710, US

(21) Appl. No.: 12/581,538

(22) Filed: Oct. 19, 2009

Related U.S. Application Data
(63) Continuation of application No. PCT/EP2008/054258, filed on Apr. 9, 2008.

(30) Foreign Application Priority Data
Apr. 19, 2007 (DE) 10 2007 018528.8

(51) Int. Cl. F26B 13/04

(52) U.S. Cl. 34/110

(57) ABSTRACT

A drying and smoothing apparatus for a machine which produces or processes a layer of material, specifically for machines that produce or process paper, cardboard or tissue, the drying and smoothing apparatus including a heated drying and smoothing cylinder having a curved external surface, the drying and smoothing cylinder configured to rotate, a pressurizing jacket encasing a portion of a curved external surface of the drying cylinder to form a pressure zone, a plurality of stacked sealing assemblies configured to seal the pressure zone from an ambient, the plurality of stacked sealing assemblies being supported on a first end and a second end of the curved surface of the drying and smoothing cylinder, wherein each of the plurality of stacked sealing assemblies include at least three seals, the seals pressed inward against the curved external surface of the drying and smoothing cylinder and stacked in sequence axially outward from the pressure zone to the ambient.

### CROSS REFERENCE TO RELATED APPLICATIONS

This is a continuation of PCT application No. PCT/EP2008/054258, entitled “PAPER MACHINE”, filed Apr. 9, 2008, which is incorporated herein by reference.

### BACKGROUND OF THE INVENTION

1. Field of the Invention

The present invention relates to a device to facilitate the drying or polishing (or smoothing) process for a machine which produces or processes a layer of material, specifically for machines that produce or process paper, cardboard, or tissue.

2. Description of the Related Art

The production of fibrous layers of material requires a drying apparatus. The capacity of these drying assemblies can be improved if drying is facilitated by condensation. To achieve this typically requires a device that commonly consists of a rotating, heated drying cylinder, as well as a pressurizing jacket which encases a large portion of the curved surface of the drying cylinder, thus forming a pressure zone which contains pressurized fluid. This pressurizing jacket is stationary relative to the rotating, heated drying cylinder. Typically there's a sandwich configuration of several components introduced between the pressurizing jacket and the cylindrical surface of the drying cylinder, the sandwich configuration consisting of a band which is impermeable to the fluid, a sieve which is permeable to the fluid and the layer of fibrous material. The configuration is such that the impermeable band is adjacent to the pressurizing jacket and the layer of fibrous material is adjacent to the rotating, heated drying cylinder. To seal the pressure zone in such a drying apparatus, one typically employs seal configurations comprised of one, but no more than two seals at each end. The seals are oriented along the radial circumference of the heated drying cylinder and pressed outwardly, against the impermeable band. Since the aforementioned seals remain stationary relative to the outer curved surface of the rotating, heated drying cylinder, they are in fact dragging seals that are subject to considerable wear and often tear or break, which causes unplanned downtimes in the currently used drying equipment.

Another issue known to trouble the aforementioned drying equipment is the limitation of the seals around the pressure zones, as they are prone to leakage during long-term usage when the fluid pressure exceeds 3 bar. Drying equipment with these sealing arrangements is, therefore, considered ill-suited for extended operation times.

What is needed in the art is a drying apparatus with an improved sealing arrangement that better contains the fluid and allows for extended operation with less propensity for unplanned down times.

### SUMMARY OF THE INVENTION

The present invention provides a drying device that contains a rotating, heated drying or smoothing cylinder, which is partially encased around its radial circumference by a pressurizing jacket. This pressurizing jacket is stationary relative to the rotating, heated drying cylinder and shaped such that it opens up towards the drying cylinder and thus forms a pressure zone, which contains pressurized fluid. Sealing sequences are supported at both ends of the curved external surface of the drying cylinder so that the fluid is axially contained within the pressure zone, whereby each sealing sequence consists of at least seals that are pressed inwardly against the exterior curved surface of the drying cylinder and are arranged in sequence such that they are stacked in the axial direction, going away from the pressure zone.

The present invention provides a dryer device with a sealing sequence with several seals that are stacked axially outward from the pressure zone, which makes it possible to successively step down the fluid pressure, so that the exterior seals at each end need to only contain little, if any, excess fluid pressure.

An advantage of the present invention is that in case of one of the seals breaking during operation of the drying apparatus, operation can be continued for a period of time until the next planned maintenance interval. The apparatus operating with only two successive seals and a jacket pressure of 3 bar is, if less than optimum, is still sufficient to allow running the apparatus for short time. By providing at least three seals it is, therefore, possible to continue operating the drying apparatus with jacket pressure of 3 bar or more with one seal failure until the next planned maintenance interval.

One embodiment of the present invention provides that the seals further extend in the radial direction or in the axial direction of the external curved surface of the drying cylinder. Keeping with the sealing arrangement of the present invention, this embodiment is intended to provide fluid containment within the pressure zone towards the side and/or in the axial direction.

Sufficient containment is attained when the press forces against the external curved surface of the drying cylinder are stronger near the pressure zone and are successively reduced for the seals that are further away. This reduction in pressure force will reduce the wear and tear of the seals that are closer to the ambient. Certain benefit is expected from the ability to adjust the forces of the different seals pressing against the exterior curved surface of the drying cylinder independently from one another.

In order to reduce the wear and tear of the seals closest to the pressure zone, which must maintain a high level of fluid containment, it is possible to adjust their pressure force such that some fluid is allowed to pass between the external curved surface of the drying cylinder and the interior surface of the seal and thereby act as lubricant. Along this line, it would be equally advantageous to similarly adjust the pressure forces between the seals further away from the pressure zone up to those that are adjacent to the ambient, so that some fluid can pass from the pressure zone out, in-between the interior surfaces of these seals and the external curved surface of the drying and smoothing cylinder and also between the external curved surface of the drying and smoothing cylinder and the adjoining impermeable band. The pressure forces acting on the external seals outward, adjacent to the ambient may further be adjusted such that no fluid can pass from the pressure zone out in-between the interior surfaces of these seals and the external curved surface of the drying and smoothing cylinder and also between the external curved surface of the drying and smoothing cylinder and the adjoining impermeable band. These adjustments ensure that the interior seals which provide the most containment are lubricated by the escaping fluid, which contain mostly water, so that these seals will be subjected to considerably reduced wear and tear in spite of the larger pressure forces acting on them.

For good drying efficiency, the fluid is pressurized to about 3 bar and kept at a temperature between about 40° C. (104° F.) and up to about 100° C. (212° F.), and if the drying and smoothing cylinder is heated by steam that is kept at a temperature between 100° C. (212° F.) and 250° C. (482° F.).

The successively arranged seals are each separated by intermittent chambers. The fluid, which passes between the sealed surfaces, can accumulate inside these intermittent chambers. Each of these intermittent chambers may be connected to recirculation lines which allow fluid that has accumulated in these intermittent chambers to run off or could be drained off, such as by use of active suction. This prevents the fluid that has accumulated inside the intermittent chambers to build up until the pressure inside the intermittent chambers would be sufficient to increase the rate of leakage out of the chamber toward the ambient. The fluid accumulated inside the intermittent chambers closest to the ambient is drained using active suction so that even as the seals are pressed with little force against the curved external surface of the drying and smoothing cylinder no fluid passes out into the ambient.

The seals are pressed against the external curved surface of the drying and smoothing cylinder by a biasing member, such as springs and/or expansion hoses.

A drying apparatus, according to the present invention, furthermore contains a sandwich of several items between the pressurizing jacket and the cylindrical surface of the drying cylinder including a band that is impermeable to the fluid, a sieve or layer of felt which is permeable to the fluid and the layer of fibrous material, the latter being in direct contact with the external curved surface of the drying and smoothing cylinder.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a detailed section drawing of a drying apparatus according to the present invention cut longitudinally through the center axis of the drying cylinder; and

FIG. 2 is a transverse cross section drawing of the drying apparatus according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

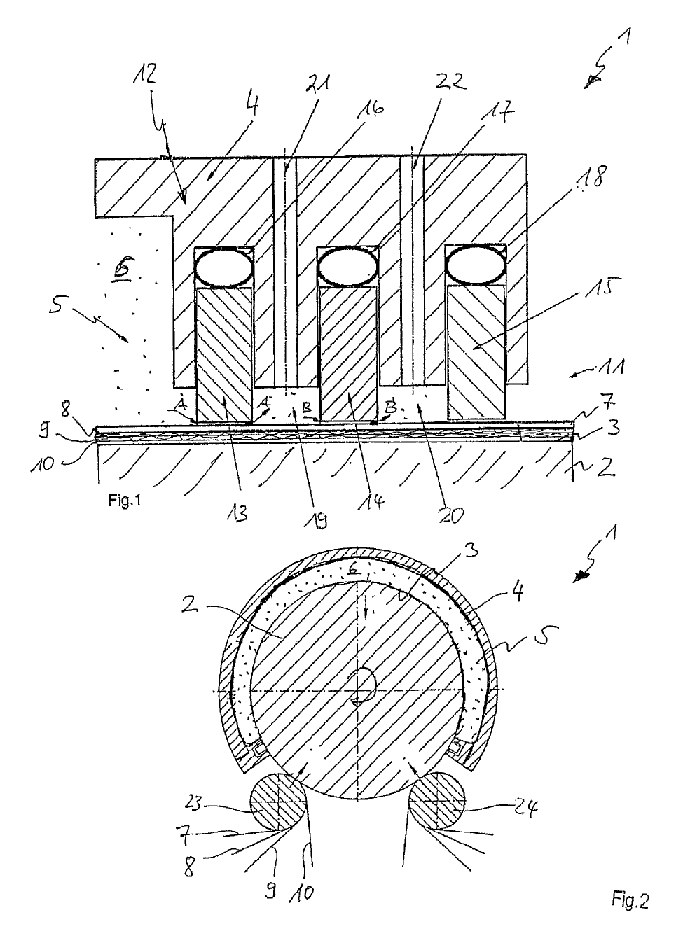

Referring now to the drawings, and more particularly to FIG. 1, there is shown, a drying apparatus 1 having a rotating drying cylinder 2 and an external curved surface 3 of drying cylinder 2 which, for the most part, is encased by a pressurizing jacket 4 that is stationary with respect to heated, spinning drying and smoothing cylinder 2. Pressurizing jacket 4 encases a large portion of curved surface 3 of drying cylinder 2, thereby forming a pressure zone 5 which contains some pressurized fluid 6.

The instance shown here presents fluid 6, such as water, kept under a pressure of about 3 bar and at a temperature of about 80° C. (176° F.).

Between pressurizing jacket 4 and curved surface 3 of drying cylinder 2 is a sandwich of several items consisting of a band 7 that is impermeable to fluid 6, two sieves 8 and 9, which are permeable to fluid 6 a well as layer of fibrous material 10, whereby band 7 is adjacent to pressurized zone 5 and fibrous material 10 is led directly along external curved surface 3 of drying cylinder 2.

Along each of the two outer sides of pressurizing jacket 4 are sealing sequences 12 that seal ambient 11 from pressurized zone 5, whereby each sealing sequence 12 consists of three seals 13, 14 and 15 that are stacked axially away from pressure zone 5 and toward ambient 11.

Each of seals 13, 14 and 15 are pressed outward by mating expansion hose 16, 17 and 18, whereby these hoses are filled and pressurized by a fluid, such as air.

As shown schematically in FIG. 1, there is intermittent chamber 19 between adjacent seals 13 and 14 and intermittent chamber 20 between adjacent seals 14 and 15, whereby each of intermittent chambers 19 and 20 are connected to recirculation lines 21 and 22, respectively, which allow any fluid 6 that has accumulated in intermittent chambers 19 and 20 to run off.

Arrows A and B, representing the direction of the flow of fluid 6, show the press force on seals 13 and 14, which precede seal 15 in sealing sequence 12 from the pressure chamber to the adjacent ambient, is chosen such that some fluid 6 can pass between seals 13 and 14 and adjacent impermeable band 7 that is supported on curved surface 3 of drying cylinder 2. Finally, the pressure force acting on seal 15, which is last in sealing sequence 12 toward ambient 11 is sufficiently high, so that no fluid 6 can pass between this seal 15 and mating curved surface 3 of drying cylinder 2 out into ambient 11. Consequently, there is no arrow showing any flow of fluid 6, past seal 15.

The schematic shown in FIG. 2 shows drying apparatus 1 cut transversely to the axis of drying cylinder 2. This section does not pass the plane along sealing sequence 12. The schematic illustrates how the sandwich consisting of the band that is impermeable to fluid 6, the two bands 8 and 9 (e.g. sieves) that are permeable to fluid 6 and layer of fibrous material 10, wraps around two roller guides 23 and 24.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A drying and smoothing apparatus for a machine which one of produces and processes a layer of material, the material being at least one of a fibrous web, paper, cardboard and tissue, the drying and smoothing apparatus comprising:
a heated drying and smoothing cylinder having a curved external surface, said drying and smoothing cylinder configured to rotate;
a pressurizing jacket encasing a portion of said curved external surface of said drying cylinder thereby forming a pressure zone which contains pressurized fluid; and
a plurality of stacked sealing assemblies configured to seal said pressure zone from an ambient, said plurality of stacked sealing assemblies being supported on axial ends of said curved surface of said drying and smoothing cylinder, each of said plurality of stacked sealing assemblies including at least three seals, said seals being pressed inward against said curved external surface of said drying and smoothing cylinder, said seals being stacked in sequence axially outward from said pressure zone to the ambient.

2. The drying and smoothing apparatus of claim 1, wherein said seals extend in at least one of a radial and an axial direction of said curved external surface of said drying and smoothing cylinder.

3. The drying and smoothing apparatus of claim 2, wherein said apparatus is configured to progressively reduce a press force applied to each of said seals inwardly against said curved external surface of said drying and smoothing cylinder from said pressure zone toward the ambient.

4. The drying and smoothing apparatus of claim 3, wherein the press force of said seals applied inwardly against said curved external surface of said drying and smoothing cylinder is stronger near said pressure zone and is successively reduced toward the ambient.

5. The drying and smoothing apparatus of claim 4, wherein the apparatus is configured to adjust the press forces applied to each of said seals such that fluid can pass from said pressure zone out between an interior surface of each of said seals that are not adjacent to the ambient and said curved external surface of said drying and smoothing cylinder, the apparatus being further configured to adjust the press force acting on said seal adjacent to the ambient such that no fluid can pass from said pressure zone out between said interior surface of each of said seals and said curved external surface of said drying and smoothing cylinder.

6. The drying and smoothing apparatus of claim 5, wherein said pressurized fluid has a pressure of at least 1.5 bar.

7. The drying and smoothing apparatus of claim 6, wherein said pressurized fluid has a pressure of approximately 3 bar.

8. The drying and smoothing apparatus of claim 7, wherein said pressurized fluid has a temperature in the range of approximately 40° C to approximately 100° C.

9. The drying and smoothing apparatus of claim 8, wherein said pressurized fluid has a temperature of approximately 80° C.

10. The drying and smoothing apparatus of claim 9, wherein said seals are separated by a plurality of intermittent chambers with at least one of said intermittent chambers being between each of said seals.

11. The drying and smoothing apparatus of claim 10, wherein said intermittent chambers are each connected to at least one recirculation line configured for allowing accumulated fluid to run off.

12. The drying and smoothing apparatus of claim 11, wherein said seals are configured to be pressed against said curved external surface of said drying and smoothing cylinder by one of a plurality of springs and a plurality of expansion hoses.

13. The drying and smoothing apparatus according to claim 12, further comprising a band that is impermeable to fluid and at least one of a felt that is impermeable to fluid and at least one permeable sieve, wherein the layer of material is a fibrous layer, said band being mated against said seals, said fibrous layer being mated directly against said curved external surface of said drying and smoothing cylinder.
